(19) United States
(12) Patent Application Publication
(10) Pub. No.: US 2018/0039207 A1
(43) Pub. Date: Feb. 8, 2018

(54) RELEASE LAYER

(71) Applicant: HP Indigo B.V., Amstelveen (NL)

(72) Inventors: Oshra Raviv, Ness Ziona (IL); Carlos Teper, Ness Ziona (IL); Roy Lubinski, Ness Ziona (IL); Gabi Habibi, Ness Ziona (IL); Dorit Yacobovich, Ness Ziona (IL); Elina Ploshink, Ness Ziona (IL); Regina Guslitzer, Ness Ziona (IL)

(73) Assignee: HP Indigo B.V., Amstelveen (NL)

(21) Appl. No.: 15/547,794

(22) PCT Filed: Apr. 24, 2015
(86) PCT No.: PCT/EP2015/058971

§ 371 Date: Jul. 31, 2017

(51) Int. Cl. G03G 15/16; G03G 9/08; G03G 9/113; G03G 9/087

(52) U.S. Cl. CPC G03G 15/16; G03G 9/08797; G03G 9/0802; G03G 9/0823; G03G 9/1131

(57) ABSTRACT

Herein is disclosed a method of coating a web with a release formulation. The method comprising: providing a coating station comprising a rotatable applicator roller to apply a release formulation coating to a web; applying a release formulation coating to a surface of the applicator roller, the release formulation comprising at least one silicone oil; feeding the web through the coating station such that the web engages with the applicator roller; and applying the release formulation coating to the web under a shearing force by rotating the applicator roller such that, at a location at which the web and the applicator roller engage, the surface of the applicator roller moves in the opposite direction to the direction the web is fed through the coating station.

Electrostatic printing processes may involve creating a latent electrostatic image on a photoconductive surface, applying an imaging material having charged particles to the photoconductive surface such that the charged particles selectively bind to the latent electrostatic image while the background areas remain clean, and then transferring the charged particles in the form of the image to a print substrate.

The photoconductive surface may be on a cylinder and is often termed a photo-imaging plate (PIP). The photoconductive surface is selectively charged with a latent electrostatic image having image and background areas with different potentials. For example, an electrostatic ink composition comprising charged toner particles in a carrier liquid can be brought into contact with the selectively charged photoconductive surface. The charged toner particles adhere to the image areas of the latent image while the background areas remain clean. The image is then transferred to a print substrate (e.g. paper).

Electrostatic printing systems sometimes employ an intermediate transfer member (ITM) to transfer the charged particles, for example charged toner particles in a carrier liquid, from a photoconductive surface to a print substrate. The ITM may include a release layer which may absorb some of the liquid carrier and facilitate releasing of the charged toner particles to the print substrate.

Some previous methods of applying a release layer to a body of the ITM have been found to cause difficulties in controlling the surface roughness of the release layer.

### BRIEF DESCRIPTION OF THE FIGURES

FIG. 1 is a schematic illustration of an example of a coating station used in a method of coating a web with a release formulation;

FIG. 2 is a schematic illustration of an example of a coating station used in a method of coating a web with a release formulation;

FIG. 3 is a schematic illustration of an example of a coating station used in a method of coating a web with a release formulation;

FIG. 4 is a schematic illustration of an example of a coating station used in a method of coating a web with a release formulation;

FIG. 5 is a schematic illustration of a reference example of a coating station used in a reference method of coating a web with a release;

FIG. 6 is a cross-sectional schematic illustration of an example of a rubber blanket as described herein;

FIG. 7 is a cross-sectional schematic illustration of an example of an ITM as described herein;

FIG. 8 is a schematic illustration of a Liquid Electro Photographic (LEP) printing apparatus comprising an ITM as described herein; and

FIG. 9 is a graph showing “fog” behaviour of images printed using ITMs having blankets obtained using different coating methods.

### DETAILED DESCRIPTION

Before the methods, release layers, intermediate transfer members and related aspects are disclosed and described, it is to be understood that this disclosure is not limited to the particular process features and materials disclosed herein because such process features and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a”, “an”, and “the” include plural references unless the context clearly dictates otherwise.

As used herein, “copolymer” refers to a polymer that is polymerized from at least two monomers.

If a standard test is mentioned herein, unless otherwise stated, the version of the test to be referred to is the most recent at the time of filing this patent application.

As used herein, “electrostatic ink composition” generally refers to an ink composition that is typically suitable for use in an electrostatic printing process, sometimes termed an electrophotographic printing process. The electrostatic ink composition may include chargeable particles of the resin and the pigment dispersed in a liquid carrier.

As used herein, “electrostatic printing” or “electrophotographic printing” generally refers to the process that provides an image that is transferred from a photo imaging substrate either directly, or indirectly via an intermediate transfer member, to a print substrate. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g. an electric field having a field gradient of 1000 V/cm or more, or in some examples 1500 V/cm or more.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

All viscosities described herein are viscosities determined at 25° C. unless stated otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Sizes, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Unless otherwise stated, any feature described herein can be combined with any aspect or any other feature described herein.

In an aspect, there is provided an intermediate transfer member (ITM) comprising an outer release layer having an average surface roughness, Sa, of less than about 3 μm.

In an aspect, there is provided a method of coating a web with a release formulation. The method may comprise:
providing a coating station comprising a rotatable applicator roller to apply a release formulation coating to a web;
applying a release formulation coating to a surface of the applicator roller, the release formulation comprising at least one silicone oil;
feeding the web through the coating station such that the web engages with the applicator roller; and
applying the release formulation coating to the web under a shearing force by rotating the applicator roller such that, at a location at which the web and the applicator roller engage, the surface of the applicator roller moves in the opposite direction to the direction the web is fed through the coating station.

In some examples, the coating station further comprises a rotatable impression roller, and the method comprises providing a nip point between the impression roller and the applicator roller at which the impression roller and the applicator roller engage with the web and the release formulation coating is applied to the web from the applicator roller.

In some examples, the location at which the web and the applicator roller engage is at a nip point between the applicator roller and an impression roller.

In some examples, the method further comprises counter-rotating an impression roller and the applicator roller, such that at a nip point between the impression roller and the applicator roller the surfaces of the applicator roller and the impression roller both move in the opposite direction to the direction in which the web is fed through the coating station.

In some examples, the method further comprises doctoring, for example, using a doctor blade, the release formulation coating on the surface of the applicator roller to leave a pre-determined thickness of release formulation on the surface of the applicator roller.

In some examples, the applicator roller comprises gravure cells on the surface of the applicator roller to accommodate a release formulation applied to the applicator roller, and applying a release formulation to the applicator roller comprises applying the release formulation to the surface of the applicator roller such that the gravure cells are filled with release formulation and doctoring the release formulation coating on the surface of the applicator roller to leave a pre-determined thickness of release formulation on the surface of the applicator roller.

In some examples, the coating station further comprises a gravure roller comprising gravure cells to accommodate a release formulation, the method comprising positioning the gravure roller to apply a release formulation to the applicator roller.

In some examples, applying a release formulation to the applicator roller comprises: applying the release formulation to the surface of a gravure roller such that gravure cells of the gravure roller are filled with a release formulation; doctoring the release formulation on the surface of the gravure roller to leave a pre-determined thickness of release formulation on the surface of the gravure roller; and transferring the pre-determined thickness of the release formulation on the surface of the gravure roller to the applicator roller.

In some examples, the speed of the applicator roller at the location at which the web and the applicator roller engage, for example at a nip point between the applicator roller and an impression roller (where present), is between about 50% and about 150% of the speed at which the web is fed through the coating station. In some examples, the speed of the applicator roller at the location at which the web and the applicator roller engage is between about 110% and about 120% of the speed at which the web is fed through the coating station.

### Release Formulation

In some examples, the release formulation comprises at least one silicone oil having alkene groups linked to the silicone chain of the silicone oil and a cross-linker comprising a silicone hydride component. In some examples, such release formulations, on curing, may form a release layer comprising the cross-linked addition cured product of at least one silicone oil having alkene groups linked to the silicone chain of the silicone oil and a cross-linker comprising a silicone hydride component.

In some examples, the release formulation may contain a catalyst, for example a platinum containing catalyst or a rhodium containing catalyst.

In some examples, the at least one silicone oil may comprise a polysiloxane having at least two alkene groups per molecule.

In some examples, the silicon hydride component may comprise a polysiloxane having a silicon hydride moiety.

In some examples, the at least one silicone oil has the formula (I):

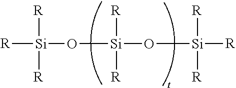

wherein:
each R is independently selected from C₁₋₆ alkyl and C₂₋₆ alkenyl groups, at least two R groups being an alkenyl group; and
t is an integer of at least 1, in some examples at least 10, in some examples at least 100.

In some examples, the alkenyl groups are vinyl groups and the alkyl groups are methyl groups.

In some examples, the silicone oil has a dynamic viscosity of 100 mPa·s or more, in some examples 200 mPa·s or more, in some examples 300 mPa·s or more, in some examples 400 mPa·s or more.

In some examples, the silicone oil has a dynamic viscosity of 5000 mPa·s or less, in some examples 1000 mPa·s or less, in some examples 900 mPa·s or less, in some examples 800 mPa·s or less, in some examples 700 mPa·s or less, in some examples 600 mPa·s or less.

In some examples, the silicone oil has a dynamic viscosity of 100 to 5000 mPa·s, in some examples 100 to 1000 mPa·s, in some examples 200 to 1000 mPa·s, in some examples 200 to 900 mPa·s, in some examples 300 to 800 mPa·s, in some examples 400 to 700 mPa·s, in some examples 400 to 600 mPa·s, in some examples about 500 mPa·s.

In some examples, the silicone oil comprises a dimethylsiloxane homopolymer, in which the alkene groups are vinyl, and are each covalently bonded to end siloxyl units. In some examples, the silicone oil comprises a dimethylsiloxane homopolymer of the α,ω(dimethyl-vinylsiloxy)poly(dimethylsiloxyl) type. In some examples, the dimethylsiloxane homopolymer has a dynamic viscosity of at least 100 mPa·s. In some examples, the dimethylsiloxane homopolymer has a dynamic viscosity of from 100 to 1000 mPa·s, in some examples 200 to 900 mPa·s, in some examples 300 to 800 mPa·s, in some examples 400 to 700 mPa·s, in some examples 400 to 600 mPa·s, in some examples about 500 mPa·s.

In some example, the silicone oil comprises a co-polymer of vinylmethylsiloxane and dimethylsiloxane, and in some examples, a vinyl group is covalently bonded to each of the end siloxyl units of the co-polymer. In some examples the co-polymer of vinylmethylsiloxane and dimethylsiloxane is of the poly(dimethylsiloxyl)((methylvinylsiloxy)α,ω(dimethyl-vinylsiloxy) type.

In some examples, the silicone oil comprises a dimethylsiloxane homopolymer, in which the alkene groups are vinyl, and are each covalently bonded to end siloxyl units, which may be as described above and a co-polymer of vinylmethylsiloxane and dimethylsiloxane, and, in some examples a vinyl group is covalently bonded to each of the end siloxane units of the co-polymer.

In some examples, the co-polymer of vinylmethylsiloxane and dimethylsiloxane has a dynamic viscosity of from 1000 to 5000 mPa·s. In some examples, the co-polymer of vinylmethylsiloxane and dimethylsiloxane has a dynamic viscosity of from 2000 to 4000 mPa·s, in some examples a dynamic viscosity of from 2500 to 3500 mPa·s, in some examples a dynamic viscosity of about 3000 mPa·s.

The silicon hydride component may comprise a polysiloxane having a silicon hydride (Si—H) moiety. The silicon hydride moiety may be at an end siloxyl unit or an intermediate siloxyl unit in the polysiloxane of the silicon hydride component. In some examples, the silicon hydride component is selected from a polysiloxane of the poly(dimethylsiloxy)-(siloxymethylhydro)-α,ω-(dimethylhydrosiloxy) type and α,ω-(dimethylhydrosiloxy) poly-dimethylsiloxane. In some examples, the polysiloxane having a silicon hydride (Si—H) moiety has a dynamic viscosity of at least 100 mPa·s, in some examples at least 500 mPa·s. In some examples, the polysiloxane having a silicon hydride (Si—H) moiety has a dynamic viscosity of from 100 mPa·s to 2000 mPa·s, in some examples a dynamic viscosity of from 300 mPa·s to 1500 mPa·s, in some examples a dynamic viscosity of from 500 mPa·s to 1300 mPa·s, in some examples a dynamic viscosity of from 700 mPa·s to 1100 mPa·s, in some examples a dynamic viscosity of from 800 mPa·s to 1000 mPa·s, in some examples a dynamic viscosity of around 900 mPa·s.

In some examples, viscosities described herein may be determined according to ASTM D4283-98(2010) Standard Test Method for Viscosity of Silicone Fluids. In some examples, viscosities described herein may be measured on a viscometer, such as a Brookfield DV-II+ Programmable viscometer, using appropriate spindles, including, but not limited to, a spindle selected from spindle LV-4 (SP 64) 200-1,000 [mPa·s] for Newtonian fluids (pure silicones) and spindle LV-3 (SP 63) 200-400000 [mPa·s] for non-Newtonian fluids (silicone oils with carbon black additives or other fillers).

In some examples, the release formulation may comprise a silicone oil comprising a silanol terminated polysiloxane and a condensation cure cross-linker component. In some examples, the silanol terminated polysiloxane may be a silanol terminated polydimethlysiloxane. In some examples, silanol terminated polysiloxane may comprise at least two silanol groups per molecule. In some examples, a release formulation comprising a silanol terminated polysiloxane may further comprise a condensation cure cross-linking catalyst. In some examples, the condensation cure cross-linking catalyst may be a tin containing catalyst. In some examples the condensation cure cross-linker component may be an acetoxy silane component, an alkoxy silane component, an oxime component, an enoxy silane component, an amino silane component, or a benzamido silane component. In some examples, such release formulations may form, on curing, a release layer comprising the cross-linked condensation cured product of at least one silanol terminated polysiloxane.

In some examples, the release formulation has a viscosity of 100 to 20000 mPa·s.

### Intermediate Transfer Member (ITM)

In an aspect, there is provided an intermediate transfer member (ITM) for use in an electrostatic printing process. The ITM may comprise:
a rubber blanket comprising a release layer disposed on a web obtainable by a method described above; and
a base on which the blanket is disposed.

In some examples, the release layer has an average surface roughness, Sa, of less than about 3 μm. In some examples, the release layer has an average surface roughness, Sa, of less than about 2.5 μm. In some examples, the release layer has an average surface roughness, Sa, of less than about 2 μm.

The average surface roughness, Sa, is the arithmetic mean surface height evaluated over the complete 3D surface of the release layer.

The average surface roughness, Sa can be evaluated mathematically as follows:

Sₐ=∫∫ₐ|Z(x,y)|dxdy

Where Z(x,y) is a function representing the height of the surface relative to the surface relative to the best fitting plane or cylinder. The “a” used in the above integral expression is used to note that integration is performed over the area of measurement and then normalised by the cross-sectional area of the measurement.

The average surface roughness, Sa, may be determined using an optical microscope having the ability to scan in the z-axis. For example, Sa may be determined using LEXT 3D Measuring Laser Microscope OSL4000, by Olympus corporation to scan the 3D image of the surface of the release layer and applying a LEXT program imaging analysis algorithm (according to the mathematical definition of Sa above) to the scanned image.

In an aspect, there is provided an intermediate transfer member (ITM) for use in an electrostatic printing process. The ITM may comprise:
a base; and
a rubber blanket disposed on the base, the rubber blanket comprising a release layer disposed on a web,
   wherein the release layer comprises the cross-linked addition cured product of at least one silicone oil having alkene groups linked to the silicone chain of the silicone oil and a cross-linker comprising a silicone hydride component, the release layer having an average surface roughness, Sa, of less than 3 μm.

In some examples, the release layer may have a thickness of about 3 μm or greater.

In some examples, the release layer may have a thickness of about 5 μm or greater.

In some examples, the release layer may have a thickness of about 7 μm or greater.

In some examples, the release layer has a thickness of about 3 μm to about 20 μm.

In some examples, the release layer has a thickness of about 5 μm to about 20 μm.

In some examples, the release layer has a thickness of about 7 μm to about 20 μm.

In some examples, the release layer has a thickness of about 7 μm to about 15 μm.

In some examples, the release layer has a thickness of about 5 μm to about 17 μm.

In some examples, the base of the ITM may have a cylindrical shape, as such the ITM may be suitable for use as a roller, for example a roller in a printing apparatus. In some examples, the base is a metal base.

The web may comprise a layered structure on which a release layer may be disposed. The layered structure may comprise a rubber layer, on which the release layer may be disposed.

The rubber blanket may be a section of a web on which a release layer is disposed. The rubber blanket may comprise a layered structure on which the release layer is disposed. The layered structure may be disposed on the base of the ITM.

The layered structure may comprise a rubber layer comprising an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ or FLS), a fluorocarbon rubber (FKM or FPM) or a perfluorocarbon rubber (FFKM).

The layered structure may comprise a primer layer to facilitate bonding or joining of the release layer to the rubber layer. In some examples, the primer layer is disposed on the rubber layer.

In some examples, the primer layer may comprise an organosilane. In some examples, the organosilane may be an organosilane derived from an epoxysilane such as 3-glycidoxypropyl trimethylsilane.

In some examples, the primer layer may comprise a catalyst. In some examples the catalyst may be a titanium containing catalyst and/or platinum containing catalyst. In some examples the catalyst may be a tin containing catalyst.

In some examples, the primer layer may comprise an organosilane, for example, an organosilane derived from an epoxysilane such as 3-glycidoxypropyl trimethylsilane, a vinyl silane such as vinyltriethoxysilane, a vinyltriethoxysilane, an allyl silane, or an unsaturated silane. In some examples, the primer layer may comprise a catalyst. In some examples the catalyst may be a titanium containing catalyst and/or platinum containing catalyst.

The primer layer may be formed from a curable primer layer. The curable primer layer may be applied to the rubber layer of the web of the rubber blanket of the ITM before the release layer is formed on the web. The curable primer layer may comprise an organosilane and a catalyst. In some examples, the catalyst may be a platinum containing catalyst.

In some examples the organosilane contained in the curable primer layer is selected from an epoxysilane, a vinyl silane, an allyl silane, an unsaturated silane, or combinations thereof.

The curable primer layer may comprise a first primer and a first catalyst, and a second primer and a second catalyst. The first primer and/or the second primer may comprise an organosilane. The organosilane may be selected from an epoxysilane, a vinyl silane, an allyl silane and an unsaturated silane.

In some examples, the first catalyst is a catalyst for catalysing a condensation cure reaction, for example a catalyst comprising titanium. The first primer may be cured by a condensation reaction by the first catalyst. In some examples, the second primer may be cured by a condensation reaction by the first catalyst.

In some examples, the second catalyst is a catalyst for catalysing an addition cure reaction. In such cases, the second catalyst may catalyse an addition cure reaction of the release formulation to form the release layer.

The curable primer layer may be applied to the rubber layer as a composition containing the first and second primer and first and second catalyst.

In some examples the curable primer layer may be applied to the rubber layer as two separate compositions, one containing the first primer and first catalyst, the other containing the second primer and second catalyst.

In some examples, the ITM may comprise an adhesive layer for joining the rubber layer to the base. The adhesive layer may comprise or consist of a fabric layer, for example a woven or non-woven cotton, synthetic, combined natural and synthetic, or treated, for example, treated to have improved heat resistance, material.

The rubber layer may be formed of a plurality of rubber layers. For example, the rubber layer may comprise a compressible layer, a compliance layer and/or a conductive layer.

In some examples, the compressible layer may be disposed on the base of the ITM.

In some examples, the compressible layer may be joined to the base of the ITM by the adhesive layer. In some examples, a conductive layer may be disposed on the compressible layer. In some examples, the compliance layer may then be disposed on the conductive layer if present, or disposed on the compressible layer if no conductive layer is present.

The compressible layer may be a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FLS or FMQ), or a fluorocarbon rubber (FKM or FPM) or a perfluorocarbon rubber (FFKM).

The compliance layer may comprise a soft elastomeric material having a Shore A hardness of less than about 65, or a Shore A hardness of less than about 55 and greater than about 35, or a Shore A hardness value of between about 42 and about 45. In some examples, the compliance layer 27 comprises a polyurethane or acrylic. Shore A hardness may be determined by ASTM standard D2240.

In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FLS or FMQ), a fluorocarbon rubber (FKM or FPM) or a perfluorocarbon rubber (FFKM)

The conductive layer may comprise a rubber, for example an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FLS or FMQ), a fluorocarbon rubber (FKM or FPM) or a perfluorocarbon rubber (FFKM) and a conductive material.

In some examples, the compressible layer and/or the compliance layer may be made to be partially conducting with the addition of a conductive material, for example conducting particles such as conductive carbon black or metal fibres. In some examples, where the compressible layer and/or the compliance layer are partially conducting there may be no requirement for an additional conductive layer.

Method of Coating a Web with a Release Formulation

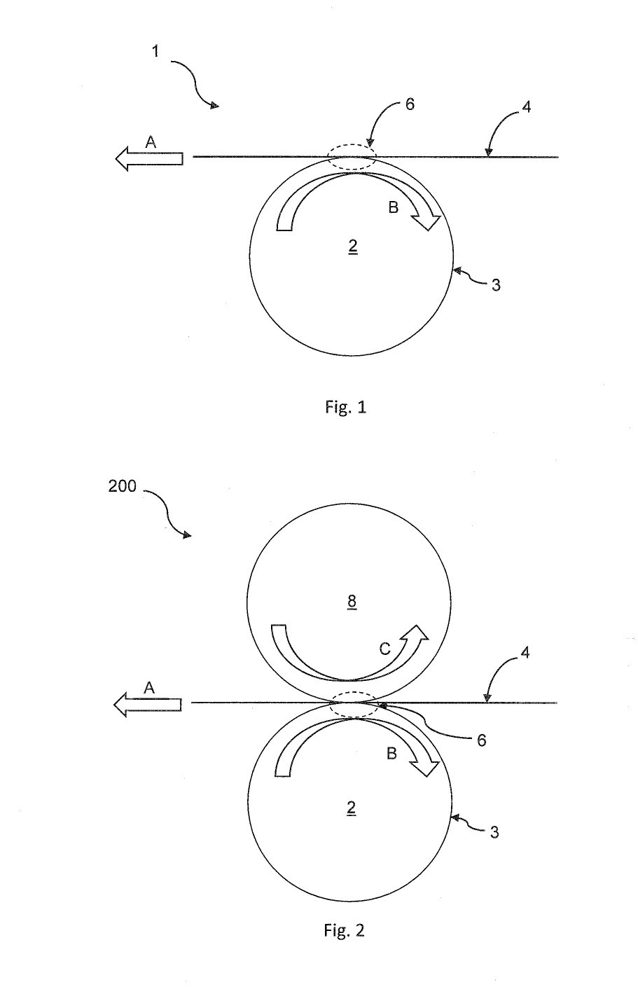

FIG. 1 shows an example of a coating station 1 which may be used in a method of coating a web 4 with a release formulation. The coating station 1 comprises a rotatable applicator roller 2 having a surface 3 to which a release formulation coating may be applied. The web 4 may be fed through the coating station 1 such that the web 4 engages with the applicator roller 2 at a location indicated by reference numeral 6 in FIG. 1. A release formulation coating may be applied to the web 4 under a shearing force by feeding the web 4 through the coating station 1 in the direction indicated by arrow A and rotating the applicator roller in the direction indicated by arrow B such that at a location 6 at which the web 4 and the applicator roller 2 engage, the surface 3 of the applicator roller 2 moves in the opposite direction to the direction the web 4 is fed through the coating station 1.

FIG. 2 shows an example of a coating station 200 used in a method coating a web 4 with a release formulation. Reference numerals used in FIG. 2 which correspond to reference numerals of FIG. 1 illustrate features corresponding to those described above in relation to FIG. 1. The coating station 200 further comprises a rotatable impression roller 8 which is positioned such as to provide a nip point 6 between the impression roller 8 and the applicator roller 2 at which the impression roller 8 and the applicator roller 2 may engage with the web 4. As the web 4 is fed through the coating station 200 in the direction shown by arrow A, a release formulation coating may be applied to the web 4 from the applicator roller 2. The impression roller 8 may be provided in order to apply pressure to the web 4 as it is moved through the nip point 6 between the applicator roller 2 and the impression roller 8, for example to ensure that a release formulation coating is transferred from the surface 3 of applicator roller 2 to the web 4. In this illustrative example, the impression roller 8 may be rotated in the direction shown by arrow C so that the applicator roller 2 and the impression roller 8 are counter-rotated such that at the nip point the surfaces of the applicator roller and the impression roller both move in the opposite direction to the direction in which the web is fed through the nip point 6 of the coating system.

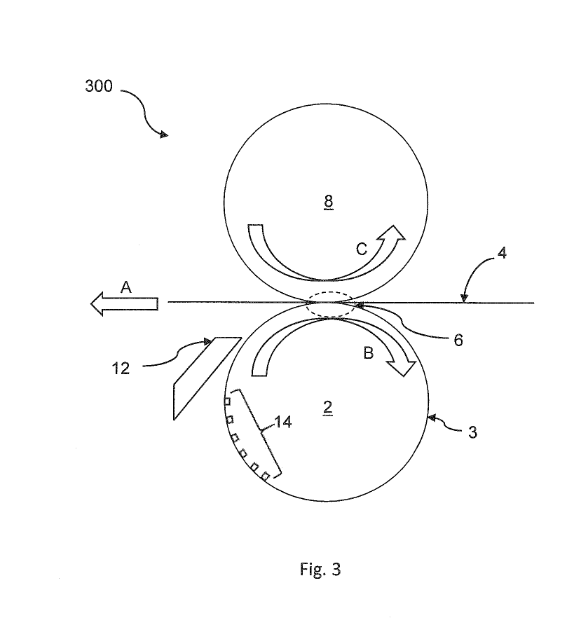

FIG. 3 shows an example of a coating station 300 used in a method coating a web 4 with a release formulation. Reference numerals used in FIG. 3 which correspond to reference numerals of FIGS. 1 and 2 illustrate features corresponding to those described above in relation to FIGS. 1 and 2. The coating station 300 further comprises a doctor blade 12 which may be used to doctor a release formulation coating applied to the surface 3 of the applicator roller 2 to leave a pre-determined thickness of release formulation coating on the surface of the applicator roller such that a pre-determined thickness of a release formulation coating may be applied to the web 4.

As illustrated in the example shown in FIG. 3, the applicator roller 2 may comprises gravure cells 14 on the surface of the applicator roller 2 for accommodating a release formulation applied to the applicator roller. In a method of coating a web 4 with a release formulation, applying a release formulation to the applicator roller may comprise applying the release formulation to the surface of the applicator roller such that the gravure cells 14 are filled with release formulation. The method may also involve doctoring the release formulation coating on the surface 3 of the applicator roller 2 using a doctor blade 12 to leave a pre-determined thickness of release formulation coating on the surface of the applicator roller 2. The pre-determined thickness of release formulation coating may then be transferred to the web 4 as the web 4 is fed through the nip point 6 between the applicator roller 2 and the impression roller 8 in the direction indicated by arrow A. The release formulation coating is applied under a shearing force as the surface 3 of the applicator roller 2, from which the release formulation coating is applied to the web 4, moves in the opposite direction (indicated by arrow B) to the direction in which the web 4 is fed through the nip point 6 (indicated by arrow A). This method described in relation to the coating station 300 shown in FIG. 3 in which a release formulation is applied to an applicator roller 2 having gravure cells 14, and then the release formulation on the surface of the applicator roller 2 is doctored to leave a release formulation coating having a pre-determined thickness on the surface of the applicator roller 2 before the release formulation coating is transferred to a web 4 under a shearing force at a nip point 6 between the applicator roller 2 and an impression roller 8 as the surface 3 of the applicator roller 2 moves in the opposite direction to the direction in which the web 4 is moved through the nip point 6 is described herein as the “reverse gravure coating method”.

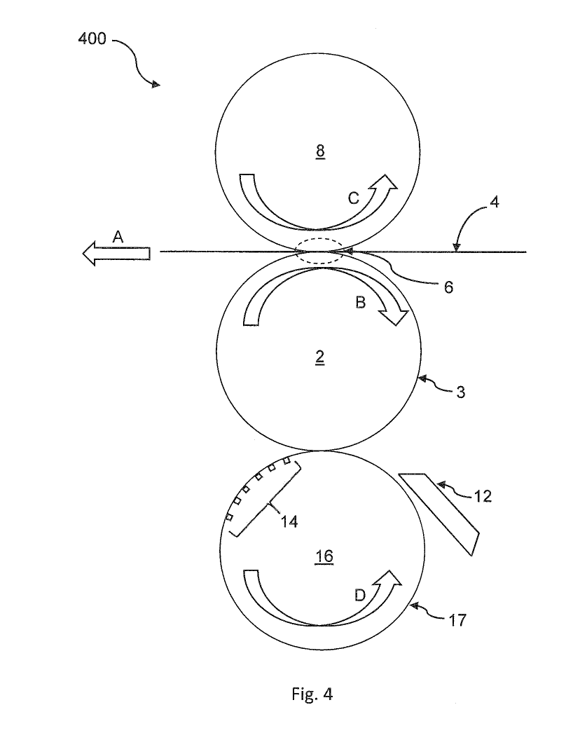

FIG. 4 shows an example of a coating station 400 used in a method coating a web 4 with a release formulation. Reference numerals used in FIG. 4 which correspond to reference numerals of FIGS. 1, 2 and 3 illustrate features corresponding to those described above in relation to FIGS. 1, 2 and 3. Coating station 400 comprises a gravure roller 16 comprising gravure cells 14 to accommodate a release formulation. In a method of coating a web 4, the method may include applying the release formulation to the surface 17 of the gravure roller 16 such that the gravure cells 14 are filled with release formulation. The method may also include doctoring the release formulation on the surface 17 of the gravure roller 16, for example using a doctor blade 12, to leave a pre-determined thickness of release formulation on the surface of the gravure roller. The method may further include transferring the pre-determined thickness of the release formulation coating from the surface 17 of the gravure roller 16 to the applicator roller 2 as the gravure roller 16 and the applicator roller 2 are counter-rotated as shown by the arrows B and D. The release formulation coating can then be transferred from the of the applicator roller 2 to the web 4 under a shearing force at a nip point 6 between the applicator roller 2 and an impression roller 8 as the surface 3 of the applicator roller 2 moves in the opposite direction to the direction in which the web 4 is moved through the nip point 6. This method described above in relation to FIG. 4 in which the coating station comprises a gravure roller 17 to which a release formulation is applied and then doctored to form a release formulation coating having a pre-determined thickness before being transferred to an applicator roller 2, the applicator roller 2 being positioned between the gravure roller 16 and the impression roller, is described herein as the “off-set reverse gravure coating method”.

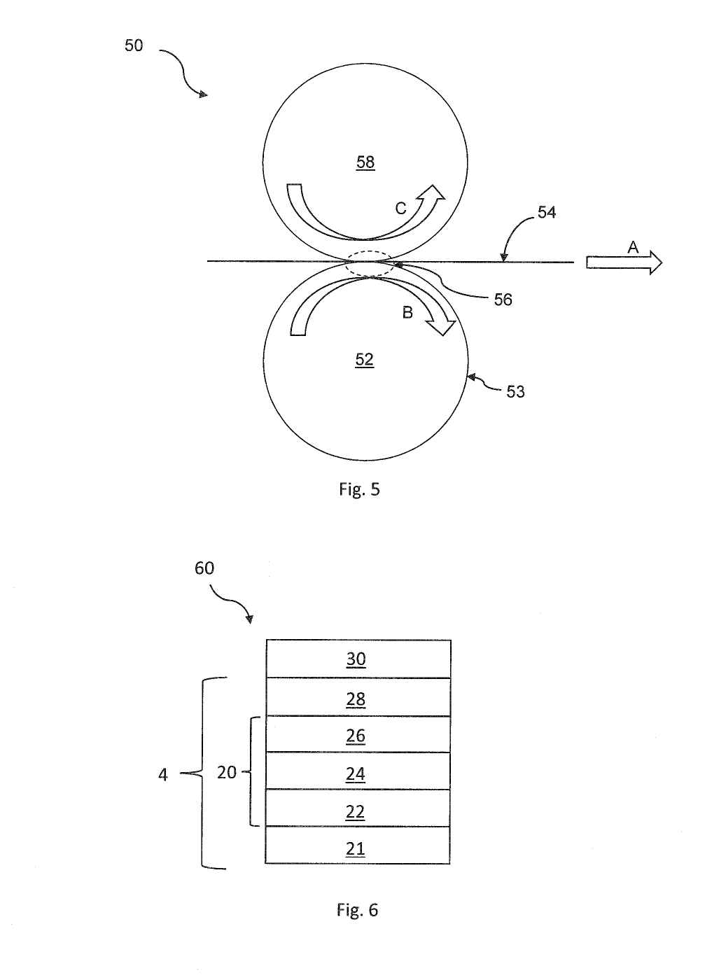

FIG. 5 shows a reference example of a coating station 50 which can be used in reference methods of coating a web 54 with a release formulation in which a web 54 is fed through a coating station 50 comprising an applicator roller 52 and an impression roller 58. At a nip point 56 between the applicator roller 52 and the impression roller 58 a release formulation may be applied to the web 54 from the applicator roller 52. At the nip point 56 the web 54 moves in the same direction (indicated by arrow A) as the direction in which the surface 53 of the applicator roller 52 is moving. This reference method is described herein as the “direct gravure coating method”.

### Rubber Blanket

FIG. 6 is a cross-sectional schematic illustration of an example of a rubber blanket 60 comprising a web 4 as described herein on which a release layer 30 has been formed. The release layer 30 may be formed on the web 4 by first coating the web 4 with a release formulation as described above. The release formulation coating on the web 4 may then be cured to form a release layer 30 disposed on the web 4, the web 4 with the release layer 30 may then be cut into sections of rubber blanket 60. A rubber blanket 60 may then be wrapped around supportive portion, such as a base cylinder, to form an intermediate transfer member (ITM).

The rubber blanket 60 illustrated in FIG. 6 comprises a web 4 on which a release layer 30 is disposed. The web 4 may comprise a rubber layer 20 on which a primer layer 28 is disposed. The release layer 30 of the rubber blanket 60 may be disposed on the primer layer 28 of the web 4.

The rubber layer 20 may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ or FLS), a fluorocarbon rubber (FKM or FPM) or a perfluorocarbon rubber (FFKM). For example, the rubber layer may comprise an at least partly cured acrylic rubber, for example an acrylic rubber comprising a blend of acrylic resin Hi-Temp 4051 EP (Zeon Europe GmbH, Niederkasseler Lohweg 177, 40547 Dusseldorf, Germany) filled with carbon black pearls 130 (Cabot, Two Seaport Lane, Suite 1300, Boston, Mass. 02210, USA) and a curing system which may comprise, for example, NPC-50 accelerator (ammonium derivative from Zeon).

The rubber layer 20 may comprise a compressible layer 22, a conductive layer 24 disposed on the compressible layer 22, and a compliance layer 26 disposed on the conductive layer 24.

The web 4 may also comprise an adhesive layer 21 on which the rubber layer 20 is disposed. The adhesive layer 21 may be a fabric layer, for example a woven or non-woven cotton, synthetic, combined natural and synthetic, or treated, for example, treated to have improved heat resistance, material. In an example the adhesive layer 21 is a fabric layer formed of NOMEX material having a thickness, for example, of about 200 μm.

The compressible layer 22 may be a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS).

The compliance layer 26 may comprise a soft elastomeric material having a Shore A hardness of less than about 65, or a Shore A hardness of less than about 55 and greater than about 35, or a Shore A hardness value of between about 42 and about 45. In some examples, the compliance layer 26 comprises a polyurethane or acrylic. Shore A hardness may be determined by ASTM standard D2240.

In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ), a fluorocarbon rubber (FKM or FPM) or a perfluorocarbon rubber (FFKM)

In some examples, the compressible layer 22 and the compliance layer 26 are formed from the same material.

In some examples, the conductive layer 24 comprises a rubber. In some examples, the rubber may be an acrylic rubber (ACM), a nitrile rubber (NBR), a hydrogenated nitrile rubber (HNBR), a polyurethane elastomer (PU), an EPDM rubber (an ethylene propylene diene terpolymer, a fluorosilicone rubber (FMQ), a fluorocarbon rubber (FKM or FPM) or a perfluorocarbon rubber (FFKM) and a conductive material. In some examples, the conductive layer 24 may be omitted. For example, the conductive layer 24 may be omitted in examples in which the compressible layer 22, the compliance layer 26, or the release layer 30 are partially conducting. For example, the compressible layer 222 and/or the compliance layer 26 may be made to be partially conducting with the addition of conductive carbon black or metal fibres.

The primer layer 28 may be provided to facilitate bonding or joining of the release layer 30 to the rubber layer 20. The primer layer 28 may comprise an organosilane, for example, an organosilane derived from an epoxysilane such as 3-glycidoxypropyl trimethylsilane, a vinyl silane such as vinyltriethoxysilane, an allyl silane, or an unsaturated silane, and a catalyst such as a titanium containing catalyst and/or a platinum containing catalyst.

In an example, a curable primer layer is applied to the rubber layer 20. In some examples, a curable primer layer is applied to the compliance layer 26 of a rubber layer 20, for example to the outer surface of a compliance layer 26 made from an acrylic rubber. In some examples, the curable primer layer may be applied using a rod coating process. In some examples, the curable primer layer may be applied using a direct gravure coating method as described herein.

In some examples, the curable primer may comprise an organosilane and a catalyst comprising tin.

In some examples, the curable primer may comprise a first primer comprising an organosilane and a first catalyst comprising titanium, for example an organic titanate or a titanium chelate. In an example the organosilane is an epoxysilane, for example 3-glycidoxypropyl trimethoxysilane (available from ABCR GmbH & Co. KG, Im Schlehert 10 D-76187, Karlsruhe, Germany, product code SIG5840) and vinyltriethoxysilane (VTEO, available from Evonik, Kirschenallee, Darmstadt, 64293, Germany), vinyltriethoxysilane, an allyl silane or an unsaturated silane. The first primer is curable by, for example, a condensation reaction. For example, the first catalyst for a silane condensation reaction may be an organic titanate such as Tyzor® AA75 (available from Dorf-Ketal Chemicals India Private Limited Dorf Ketal Tower, D'Monte Street, Orlem, Malad (W), Mumbai-400064, Maharashtra INDIA.). The primer may also comprise a second primer comprising an organosilane, e.g. a vinyl siloxane, such as a vinyl silane, for example vinyltriethoxysilane or vinyltrimethoxysilane, an allyl silane or an unsaturated silane, and, in some examples, a second catalyst. The second primer may also be curable by a condensation reaction. In some examples, the second catalyst, if present, may be different from the first catalyst and in some examples comprises platinum or rhodium. For example, the second catalyst may be a Karstedt catalyst with, for example, 9% platinum in solution (available from Johnson Matthey, 5th Floor, 25 Farringdon Street, London EC4A 4AB, United Kingdom) or a SIP6831.2 catalyst (available from Gelest, 11 East Steel Road, Morrisville, Pa. 19067, USA).

In some examples, the second catalyst is a catalyst for catalysing an addition cure reaction. In such cases the second catalyst may catalyse an addition cure reaction of the release formulation coating applied to the web 4 to form the release layer 30 when the release formulation comprises at least one silicone oil having alkene groups linked to the silicone chain of the silicone oil, for example a vinyl functional siloxane and a cross-linker comprising a silicone hydride component.

The curable primer layer applied to the rubber layer 20 may comprise a first primer and/or a second primer. The curable primer layer may be applied to the rubber layer 20 as two separate layers, one layer containing the first primer and the other layer containing the second primer.

The rubbers of the compressible layer 22, the conductive layer 24 and/or the compliance layer 26 of the rubber layer 20 may be uncured when the curable primer layer is applied thereon.

In some examples, the release layer 30 of the rubber blanket 60 may comprise the cross-linked addition cured product of at least one silicone oil having alkene groups linked to the silicone chain of the silicone oil and a cross-linker comprising a silicone hydride component.

In some examples, the release layer 30 may be formed on the web 4 by applying a release formulation coating to a web 4 as described herein. For example, the release formulation coating may be applied to the rubber layer 20 of a web 4 or on top of a curable primer layer which has already been applied to the rubber layer 20 of the web 4.

The release formulation may comprise at least one silicone oil.

In some examples, the release formulation may comprise at least one silicone oil having alkene groups linked to the silicone chain of the silicone oil and a cross-linker comprising a silicon hydride component. In some examples, the release formulation may contain a catalyst, for example a platinum containing catalyst or a rhodium containing catalyst.

In some examples, the at least one silicone oil may comprise a polysiloxane having at least two alkene groups per molecule. For example, the silicone oil may comprise a dimethylsiloxane homopolymer, in which the alkene groups are vinyl, and are each covalently bonded to end siloxyl units. In some examples, the silicone oil comprises a dimethylsiloxane homopolymer of the α,ω(dimethyl-vinylsiloxy)poly(dimethylsiloxyl) type.

In some example, the at least one silicone oil comprises a co-polymer of vinylmethylsiloxane and dimethylsiloxane, and in some examples, a vinyl group is covalently bonded to each of the end siloxyl units of the co-polymer. In some examples the co-polymer of vinylmethylsiloxane and dimethylsiloxane is of the poly(dimethylsiloxyl)((methylvinylsiloxy)α,ω(dimethyl-vinylsiloxy) type.

In some examples, the silicone oil comprises a dimethylsiloxane homopolymer, in which the alkene groups are vinyl, and are each covalently bonded to end siloxyl units, which may be as described above and a co-polymer of vinylmethylsiloxane and dimethylsiloxane, and, in some examples a vinyl group is covalently bonded to each of the end siloxane units of the co-polymer.

The silicon hydride component may comprise a polysiloxane having a silicon hydride (Si—H) moiety. The silicon hydride moiety may be at an end siloxyl unit or an intermediate siloxyl unit in the polysiloxane of the silicon hydride component. In some examples, the silicon hydride component is selected from a polysiloxane of the poly(dimethylsiloxy)-((siloxymethylhydro)-α,ω-(dimethylhydrosiloxy) type and α,ω-(dimethylhydrosiloxy) poly-dimethylsiloxane.

In some examples, the silicone oil comprises a polydimethlysiloxane.

In some examples, the release formulation may comprise a silicone oil comprising a silanol terminated polysiloxane. In some examples, the silanol terminated polysiloxane may be a silanol terminated polydimethlysiloxane. In some examples, a release formulation comprising a silanol terminated polysiloxane may further comprise a tin catalyst. In some examples, such release formulations may form a release layer comprising the cross-linked condensation cured product of at least one silanol terminated polysiloxane.

Once cured, the rubber blanket 60 comprises a release layer 30 disposed on a rubber layer 20, or, if present, disposed on a primer layer 28 of a web 4.

### Intermediate Transfer Member (ITM)

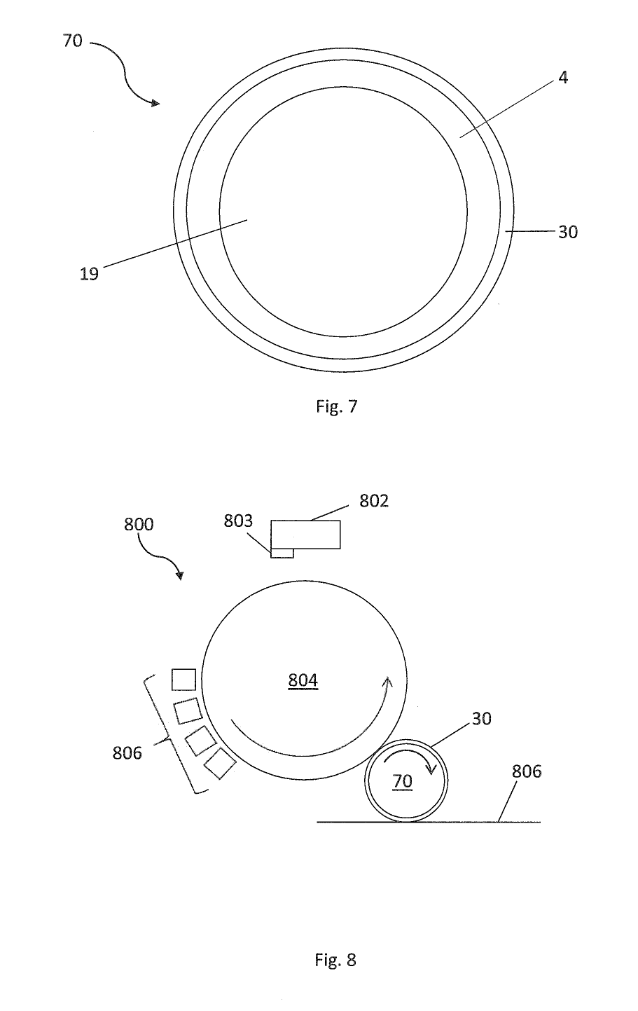

FIG. 7 is a cross-sectional schematic illustration of an ITM 70. The ITM comprises a base 19 and a web 4 (as described above) disposed on the base 19. The base 19 may be a metal cylinder. The ITM 70 also comprises a release layer 30 disposed on the web 4. The web 4 along with the release layer 30 make up the rubber blanket 60 as described above.

The ITM 70 may be formed by applying a rubber blanket 60 (as described above) to a base 19, for example wrapping a rubber blanket 60 around a metal cylinder.

### Electrostatic Liquid Electro Photographic (LEP) Printing Apparatus

FIG. 8 shows a schematic illustration of an LEP printing apparatus 800 comprising an example of an ITM 70 as described herein. An image, including any combination of graphics, text and images, is communicated to the LEP printing apparatus 800. The LEP includes a photo charging unit 802 and a photo-imaging cylinder 804. The image is initially formed on a photo-conductive member in the form of a photo-imaging cylinder 804 before being transferred (first transfer) to a release layer 30 of the ITM 70 which is in the form of a roller, and then from the release layer 30 of the ITM 70 to a print substrate 806 (second transfer).

According to an illustrative example, the initial image is formed on a rotating photo-imaging cylinder 804 by the photo charging unit 802. Firstly, the photo charging unit 802 deposits a uniform static charge on the photo-imaging cylinder 804 and then a laser imaging portion 803 of the photo charging unit 802 dissipates the static charges in selected portions of the image area on the photo-imaging cylinder 804 to leave a latent electrostatic image on the surface of the photo-imaging cylinder 804. The latent electrostatic image is an electrostatic charge pattern representing the image to be printed. Ink (for example, a liquid electrostatic ink such as ElectroInk® or any other Liquid Electro Photographic (LEP) inks developed by Hewlett-Packard Company) may then transferred to the photo-imaging cylinder 804 by Binary Ink Developer (BID) units 808. The BID units 808 present a uniform film of ink to the photo-imaging cylinder 804. The ink contains electrically charged pigment particles which are attracted to the latent electrostatic image on the photo-imaging cylinder 804. The ink is repelled from the uncharged, non-image areas and forms a developed toner image on the surface of the latent electrostatic image.

The developed toner image is then transferred from the photo-imaging cylinder 804 to the outer release layer 30 of the ITM 70 by virtue of an appropriate potential applied between the photo-imaging cylinder 804 and the ITM 70, such that the charged ink is attracted to the ITM 70. The image is then dried and fused on the release layer 30 of the ITM 70 before being transferred from the release layer 30 of the ITM 70 to a print substrate 806.

Between the first and second transfers the solid content of the developed toner image may be increased and the ink may be fused on to the ITM 70. For example, the solid content of the developed toner image deposited on the outer release layer 30 after the first transfer may be around 20%, by the second transfer the solid content of the developed toner image may be around 80-90%. This drying and fusing may be achieved by using elevated temperatures and/or air flow assisted drying. In some examples, the ITM 70 is heatable.

In some examples, a substrate primer may be applied to a print substrate before a toner image is transferred to a print substrate.

### Examples

It is to be understood that the following examples are illustrative of the application of the principles of the present methods, intermediate transfer members, release layers and related aspects. Numerous modifications and alternative methods, intermediate transfer members, release layers and related aspects may be devised by those skilled in the art without departing from the spirit and scope of the present methods, intermediate transfer members, release layers and related aspects. The appended claims are intended to cover such modifications and arrangements. Thus, while the present methods, intermediate transfer members, release layers and related aspects have been described above with particularity, the following examples provide further detail in connection with what are presently deemed to be acceptable.

### Rubber Blanket Structure and Release Formulation Coating

The rubber blanket structure from bottom to top (top is a release layer; bottom is a layer which is placed in contact with the base, i.e. metal drum of the ITM) produced and tested in the following examples was as follows:
1. Fabric based (in these examples, cotton for Gemini blanket, cotton/rayon for Iris blanket) adhesive layer having a thickness of less than 250 μm;
2. Rubber based compressible layer with large range of compressibility (in these examples, NBR containing carbon black (CB) (from ContiTech AG Vahrenwalder Str. 9 30165 Hannover Germany for Gemini blanket, from Trelleborg for the Iris blanket) having a thickness of 600-700 μm;
3. Rubber based conductive layer (in these example, NBR containing CB from ContiTech for Gemini blanket and ACM containing CB from Trelleborg for Iris blanket) having a thickness of 140-300 μm;
4. Rubber based soft compliant layer (in these examples, ACM containing CB (from ContiTech for Gemini blanket, from Trelleborg for the Iris blanket) having a thickness of 80-160 μm;
5. Primer layer coated on rubber based soft compliant layer (layer no 4) using a direct gravure coating method (as described above in relation to FIG. 5), the primer layer used depends on the release formulation to be applied to the primer layer, for the addition curable release formulations RL-26 or RL-61 the primer layer comprises a first layer containing a Primer 1 formulation and a second layer containing Primer 2 formulation, the Primer 1 and 2 formulations described in tables 1 and 2 below, for the condensation release layer the primer layer comprises Primer 3 formulation described in table 3 below; and
6. Release layer comprising the cured product of the release formulation described in table 4, table 5 or table 6 below, the release layers of these examples had a thickness of 5-17 μm as described below.

Each rubber blanket was prepared by providing a web comprising layer numbers 1 to 5 above and applying a release formulation as set out in table 3 (RL-26), table 4 (RL-61), or table 5 (condensation) to the primer layer using either a direct gravure coating method, a reverse gravure coating method or an off-set reverse gravure coating method (as described above in relation to FIGS. 1 to 5). To apply a release layer to the web using the direct gravure coating method the gravure roller was rotated with the same relative speed to the speed at which the web was fed through the coating station, in these examples a speed of 5 m/min was used. To apply a release layer to the web using the reverse gravure coating method the gravure roller was rotated with a relative speed of 150% greater than the speed at which the web was fed through the coating station, in these examples the speed of the gravure roller at the nip point was 7.5 m/min and the web was fed through the coating station at a speed of 5 m/min. To apply a release layer to the web using the off-set reverse gravure coating method the gravure roller was rotated with the same relative speed to the speed at which the web was fed through the coating station, in these examples a speed of 5 m/min was used. After the coating process was complete the whole rubber blanket was placed in an oven at 120° C. for 1.5 hr.

The gravure roller used in each coating method was selected based on the desired thickness of the release layer to be formed. For a release layer applied using a direct gravure coating method with a desired thickness of less than 7 μm a gravure roller having a surface geometry having 220 lines/inch and 60° (hexagonal) gravure cells and a gravure volume of 13.8 cm³/m² (available from Anilox) was used. For a release layer applied using a reverse gravure coating method with a desired thickness of less than 7 μm a gravure roller having a surface geometry having 120 lines/inch and 60° (hexagonal) gravure cells and a gravure volume of 32.7 cm³/m² (available from Anilox) was used. For a release layer applied using a direct gravure coating method with a desired thickness of greater than 7 μm a gravure roller having a surface geometry having 220 lines/inch and 60° (hexagonal) gravure cells and a gravure volume of 40.0 cm³/m² (available from Anilox) was used. For a release layer applied using an off-set reverse gravure coating method with a desired thickness of greater than 7 μm a gravure roller having a surface geometry having 220 lines/inch and 60° (hexagonal) gravure cells and a gravure volume of 32.7 cm³/m² (available from Anilox) was used.

TABLE 1

| | Wt. % in | |
|---|---|---|
| Primer 1 Formulation | formulation | Supplier |
| 3(Glycidoxypropyl) trimethoxysilane | 45 | ABCR |
| 3-methacryloxypropyltrimethoxysilane | 50 | ABCR |
| 2-hydroxy-2-methylpropiophenone | 5 | Ciba |

TABLE 2

| | Wt. % in | |
|---|---|---|
| Primer 2 formulation | formulation | Supplier |
| 3(Glycidoxypropyl) trimethoxysilane | 58-62 | ABCR |
| Vinyltrimethoxysilane | 26 | ABCR |
| Tyzor AA75 | 8 | DorfKetal |
| Karstedt solution 9% Pt | 4-8 | Johnson Mattey |

TABLE 3

| | Wt. % in | |
|---|---|---|
| Primer 3 formulation | formulation | Supplier |
| 3(Glycidoxypropyl) trimethoxysilane | 50 | ABCR |
| Stannous octoate | 2-5 | Sigma-Aldrich |
| o, m- or p-xylene | 45-48 | Sigma- Aldrich |

TABLE 4

| | Parts by weight in | |
|---|---|---|
| Materials - RL-26 | formulation | Supplier |
| Dimethylsiloxane vinyl terminated - | 80 | ABCR |
| VS 500 | | |
| Vinylmethylsiloxane - | 20 | ABCR |
| Dimethylsiloxane Copolymer vinyl | | |
| terminated - XPRV 5000 | | |
| Carbon black | 0-1 | Ketjenblack |
| | | 600JD from |
| | | AkzoNobel) |
| Hydride siloxane | 10 | ABCR |
| Karstedt solution 0.5% Pt | Up to 0.5 | ABCR |

TABLE 5

| | Parts by weight in | |
|---|---|---|
| Materials - RL-61 | formulation | Supplier |
| Dimethylsiloxane vinyl terminated - | 80 | ABCR |
| VS 1000 | | |
| Vinylmethylsiloxane - | 20 | ABCR |
| Dimethylsiloxane Copolymer vinyl | | |
| terminated - XPRV 5000 | | |
| Carbon black | 0-1 | Ketjenblack |
| | | 600JD from |
| | | AkzoNobel) |
| Hydride siloxane | 8.6 | ABCR |
| Karstedt solution 0.5% Pt | Up to 0.5 | ABCR |

TABLE 6

| Materials -Release | Parts by weight in | |
|---|---|---|
| condensation | formulation | Supplier |
| Poly(dimethylsiloxane), silanol | 100 | Gelest |
| terminated - DMS-S27 | | |
| Carbon black | 0.8 | Ketjenblack |
| | | 600JD from |
| | | AkzoNobel) |
| Oleic acid | 6 | Backer |
| Ethyl silicate | 5 | Colcoat CO., |
| | | LTD |
| Methylsilicate 51 | 1.5 | Colcoat CO., |
| | | LTD |
| Dibutyltin dilaurate | 1.2 | Sigma-Aldrich |

Each of the rubber blankets obtained were then applied to a metal cylinder to form an ITM. Various properties of the release layers of the rubber blankets were then tested on the ITMs in LEP printing apparatuses similar to the illustrative example of an LEP printing apparatus described in relation to FIG. 8. The tests were carried out as follows. The results are shown in Table 7 below.

### Surface Roughness

The average surface area surface roughness, Sa, was evaluated over the complete 3D surface (Arithmetic mean height (Sa)) for each release layer using an optical microscope having the ability to scan in the z-axis, in these examples a LEXT 3D Measuring Laser Microscope OSL4000, by Olympus corporation was used to determine Sa. To determine Sa for the surface of each release layer, prior to the microscope imaging, a sample of blanket was adhered to a glass plate with two-sided adhesive tape (adhered to the fabric (adhesive layer) side). The surface of the release layer cleaned 3 times by an adhesive sticker to remove any dirtiness from the surface. This cleaning does not affect the release layer surface roughness. The 3D image of the release surface was scanned by the LEXT microscope, at magnification of ×5, and the LEXT program imaging analysis algorithm (according to the mathematical definition of Sa described above) was applied on the scanned image. The results are shown in Table 7 below.

The results shown in Table 7 show that the reverse gravure coating method and the off-set reverse gravure coating method can be used to produce a release layer having a lower surface roughness than a release layer produced using a reference direct gravure coating method.

### “Fog” of Image Printed on a Print Substrate

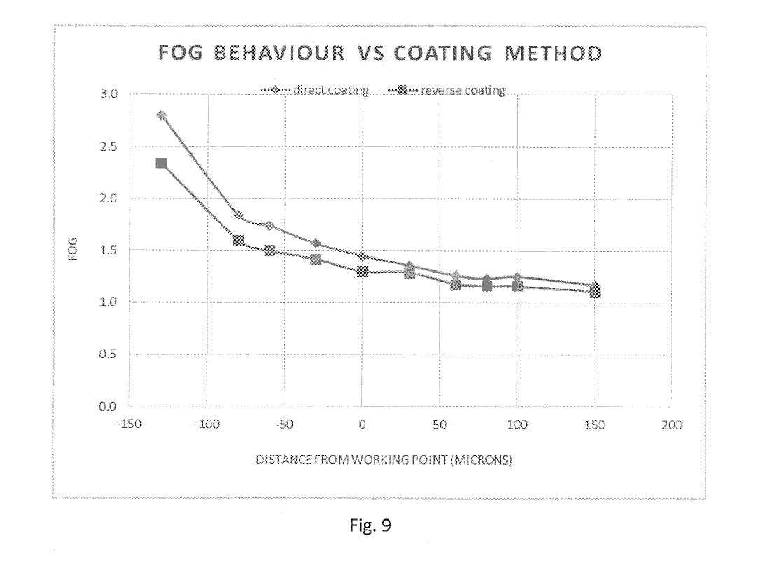

“Fog” is a print quality phenomena, it is a measurement of black solid non-uniformity. Solid black images were printed on to print substrates and the deviation of grey levels analysed in the printed area. “Fog” has been found to be reduced by using an ITM having a release layer with a lower surface roughness as can be seen from the graph shown in the graph shown in FIG. 9. The ITMs used in an LEP printing apparatus (as described above in relation to FIG. 8) to print the grey images were ITMs numbers 3 and 4 described in the table below. “Fog” is considered to be indicative of surface roughness caused by ink particles fusing into a thin film on the ITM, between the first and second transfers, following the release layer surface. For each of ITMs 3 and 4 an optimized “working point” was used, which is how much the photo-imaging cylinder 804 and the ITM 70 are pressed together during the transfer of ink from the photo-imaging cylinder 804 to the ITM 70. As the blanket 60 of the ITM 70 is formed from rubber and photo-imaging cylinder 804 is hard, the photo-imaging cylinder 804 decreases the blanket 60 thickness during the transfer of ink from the photo-imaging cylinder 804 to the ITM 70 when the photo-imaging cylinder 804 presses against the ITM 70. “Fog” was measured around the “working point”. For example, a negative value, is a distance below the “working point”, less pressure applied on the blanket 60 of the ITM 70 than the optimal working point. If the value from “working point is positive, more pressure is applied by the photo-imaging cylinder 804 to the blanket 60 of the ITM 70.

### Appearance of “Butterflies” in an Image Printed on a Print Substrate

The appearance of “butterflies” is a print quality phenomena, which can be seen as a “wavy pattern” on grey (20-80% coverage) prints. Grey images having 20-80% coverage were printed on to print substrates using a LEP printing apparatus (as described above in relation to FIG. 8) comprising ITMs described above. The presence or absence of “butterflies” was determined.

As illustrated in the results that follow, “butterflies” have been found to occur on some prints when the first transfer voltage (the potential applied between the photo-imaging cylinder and the ITM) is high (above 700V). The source of the phenomena is attributed to the surface roughness of the release layer of the rubber blanket, which is believed to be created during the coating process. The results that the appearance of “butterflies” at the higher first transfer voltages can be prevented by providing a release layer with a lower surface roughness, for example an average surface roughness, Sa, of below 3 microns.

### Interaction Between Release Layer of ITM and Substrate Primer

Many print substrates used in the printing industry may be pre-treated, such as by application of adhesive layer (substrate primer) on top of the print substrate. The substrate primer layer allows strong adhesion between the ink and the substrate.

The substrate primer can be applied before the print substrate enters the printing apparatus (off-line), or in the printing apparatus, by a priming station located before the print engine (in-line). In both cases, during the second transfer, a direct contact between the ITM (release layer) and the substrate primer occurs, at the non-printed (background) areas. This contact may lead to some transfer of the adhesive substrate primer from the print substrate to the release layer, and accumulation of the substrate primer at the non-printed areas.

The present inventors have found that accumulated substrate primer on the release layer may cause a decrease in print quality (memories, ink accumulation on blanket, second transfer failures), mechanical damage to the blanket and reduced utilization of the printing apparatus (due to frequent rubber blanket replacement). The inventors have found that lowering the surface area of the release layer, by reducing the surface roughness of the release layer using the reverse gravure and off-set reverse gravure coating methods described herein, reduces the accumulation of the substrate primer on the rubber blanket, and thus rubber blanket failures related to this phenomena.

The blankets were aged for 400 printed images and then a substrate primer solution (adhesive primer 050 (Michelman, ethylene acryl imine) was dropped onto the blanket surface using a pipette before an additional image was printed. The substrate primer solution was splashed with a pipette on the printed substrate, at a distance of 1-5 cm before the second transfer nip to produce a local excess of un-dried primer on the substrate. This excess of un-dried primer may accumulate at the background areas, where direct contact between the primed substrate and release layer occurs. At those areas a primer may accumulate and cause a rupture/tear/detachment of release layer from the blanket (called “release tear” failure). The size of “release tear” areas can vary:
a. diameter—from few microns to centimeter scale (0.01-10 cm)
b. thickness—from 1 micron to the full thickness of the release layer (1-20 microns).

The “release tear” failure is the most severe failure that may be caused by accumulated primer. It can appear on print as voids and identified as dirtiness, when the diameter is large (0.5 cm and higher), or it can appear as a memory (diameter <0.5 um), due to change in image roughness.

During the test the prints were evaluated to the presence of the “release tear” failure, as a parameter to blanket damage.

The results, presented in Table 7, show that the lower the surface roughness, lower the rate of the “release tear” failure.

The present inventors have also found that the off-set reverse gravure coating method described herein can be used to produce release layers having a thickness of about 7 μm or greater, for example, a thickness of 7-20 μm, without increase of the average surface roughness, Sa. For example, release layers having a thickness of greater than about 7 μm can be formed having an average surface roughness, Sa, of less than about 3 μm.

TABLE 7

| | | | | | | | | | Number of failed |
|---|---|---|---|---|---|---|---|---|---|
| | | | | | | | “Butterflies” | | blankets (out of |
| | | | Gravure | | Final Release | Surface | First | “Butterflies” | 3 tested) due to |
| | | Release | volume | Coating | layer thickness | roughness | transfer | appear on | application of |
| ITM No. | ITM type | formulation | (cm³/m²) | method | (microns) | (microns) | voltage (V) | gray print | substrate primer |
| 1 | Iris | Addition cure | 32.7 | Off-set reverse | About 10 | 1.7 | | | 1 |
| | | RL-61 | | gravure | | | | | |
| 2 | Iris | Addition cure | 32.7 | Reverse | 5.5-6.5 | 1.4 ± 0.2 | | | 1 |
| | | RL-61 | | gravure | | | | | |
| 3 | Gemini | Addition cure | 32.7 | Reverse | 5.5-6.5 | 1.4 ± 0.2 | 550 | No | 1 |
| | | RL-26 | | gravure | 5.5-6.5 | | 800 | No | |
| 4 | Gemini | Addition cure | 13.8 | Direct | 5.5-6.5 | 3.4 ± 0.5 | 550 | No | 3 |
| | | RL-26 | | | 5.5-6.5 | | 800 | Yes | |
| 5 | Iris | Condensation | 13.8 | Direct | 5.5-6.5 | 4.2 | | | 2 |
| | | Iris | | | | | | | |
| 6 | Iris | Addition cure | 40.0 | Direct | 14-17 | 5.6 | | | 3 |
| | | RL-26 | | | | | | | |

While the methods, release layers, intermediate transfer members and related aspects have been described with reference to certain examples, those skilled in the art will appreciate that various modifications, changes, omissions, and substitutions can be made without departing from the spirit of the disclosure. It is intended, therefore, that the methods, release layers, intermediate transfer members and related aspects be limited only by the scope of the following claims. Unless otherwise stated, the features of any dependent claim can be combined with the features of any of the other dependent claims, and any other independent claim.

1. A method of coating a web with a release formulation, the method comprising:
providing a coating station comprising a rotatable applicator roller to apply a release formulation coating to a web;
applying a release formulation coating to a surface of the applicator roller, the release formulation comprising at least one silicone oil;
feeding the web through the coating station such that the web engages with the applicator roller; and
applying the release formulation coating to the web under a shearing force by rotating the applicator roller such that, at a location at which the web and the applicator roller engage, the surface of the applicator roller moves in the opposite direction to the direction the web is fed through the coating station.

2. A method according to claim 1, wherein the coating station further comprises a rotatable impression roller, and the method comprises providing a nip point between the impression roller and the applicator roller at which the impression roller and the applicator roller engage with the web and the release formulation coating is applied to the web from the applicator roller.

3. A method according to claim 2, comprising counter-rotating the impression roller and the applicator roller, such that at the nip point the surfaces of the applicator roller and the impression roller both move in the opposite direction to the direction in which the web is fed through the coating station.

4. A method according to claim 1, further comprising doctoring the release formulation coating on the surface of the applicator roller to leave a pre-determined thickness of release formulation on the surface of the applicator roller.

5. A method according to claim 1, wherein the applicator roller comprises gravure cells on the surface of the applicator roller to accommodate a release formulation applied to the applicator roller, and applying a release formulation to the applicator roller comprises applying the release formulation to the surface of the applicator roller such that the gravure cells are filled with release formulation and doctoring the release formulation coating on the surface of the applicator roller to leave a pre-determined thickness of release formulation on the surface of the applicator roller.

6. A method according to claim 1, wherein the coating station further comprises a gravure roller comprising gravure cells to accommodate a release formulation, the method comprising positioning the gravure roller to apply a release formulation to the applicator roller.

7. A method according to claim 6, wherein applying a release formulation to the applicator roller comprises: applying the release formulation to the surface of the gravure roller such that the gravure cells are filled with release formulation; doctoring the release formulation on the surface of the gravure roller to leave a pre-determined thickness of release formulation on the surface of the gravure roller; and transferring the pre-determined thickness of the release formulation on the surface of the gravure roller to the applicator roller.

8. A method according to claim 1, wherein the speed of the applicator roller at the location at which the web and the applicator roller engage is between about 50% and about 150% of the speed at which the web is fed through the coating station.

9. A method according to claim 1, wherein the release formulation comprises at least one silicone oil having alkene groups linked to the silicone chain of the silicone oil and a cross-linker comprising a silicone hydride component.

10. A method according to claim 1, wherein the release formulation has a viscosity of about 100 to about 20000 mPa·s.

11. An intermediate transfer member (ITM) for use in an electrostatic printing process, the ITM comprising:
a rubber blanket comprising a release layer disposed on a web obtainable by the method of claim 1; and
a base on which the blanket is disposed.

12. An ITM according to claim 11, wherein the release layer has an average surface roughness, Sa, of less than 3 μm.

13. An ITM according to claim 11, wherein the release layer has a thickness of about 5 μm or greater.

14. An intermediate transfer member (ITM) for use in an electrostatic printing process, the ITM comprising:
a base; and
a rubber blanket disposed on the base, the rubber blanket comprising a release layer disposed on a web,
wherein the release layer comprises the cross-linked addition cured product of at least one silicone oil having alkene groups linked to the silicone chain of the silicone oil and a cross-linker comprising a silicone hydride component, the release layer having an average surface roughness, Sa, of less than 3 μm.

15. An ITM according to claim 14, wherein the release layer has a thickness of about 5 μm or greater.
